(19) United States
(12) Patent Application Publication
(10) Pub. No.: US 2008/0022392 A1
(43) Pub. Date: Jan. 24, 2008

(54) Resolution of attribute overlap on authentication, authorization, and accounting servers

(75) Inventors: Dan Karpati, Netanya (IL); Alon Zilberman, Givat Shmuel (IL); Eitan Ben Amos, Karkur (IL); Ido Halevi, Givat Ada (IL)

Correspondence Address: ABELMAN, FRAYNE & SCHWAB, 666 THIRD AVENUE, 10TH FLOOR, NEW YORK, NY, 10017, US

(73) Assignee: Cisco Technology, Inc.

(21) Appl. No.: 11/481,858

(22) Filed: Jul. 5, 2006

(51) Int. Cl. G06F 15/16

(52) U.S. Cl. 726/15

(57) ABSTRACT

In the establishment of a VPN tunnel, a VPN gateway is responsible for resolving user and group attribute overlaps and conflicts when more than one AAA server is accessed during authentication and authorization. An IPSec Aggregator is provided with a governing policy that anticipates such conflicts and sets out precedence rules and alternative values of attributes.

### BACKGROUND OF THE INVENTION

1. Field of the Invention

This invention relates to security on a communications network. More particularly, this invention relates to improvements in a network gateway that is responsible for approving network access by a remote client.

2. Description of the Related Art

TABLE 1
Acronyms and Abbreviations

| | |
|---|---|
| AAA | Authentication, Authorization, and |
| | Accounting |
| ACL | Access Control List |
| AV | Attribute Value |
| BGP | Border Gateway Protocol |
| CA | Certification Authority |
| DNS | Domain Name Server |
| GSR | Gigabit Switch Router |
| IKE | Internet key exchange |
| IP | Internet Protocol |
| Ipsec | IP Security |
| ISAKMP | Internet Security Association and Key |
| | Management Protocol |
| L2TP | Layer Two Tunneling Protocol |
| LAN | Local Area Network |
| PE | Provider Edge |
| PPP | Point-to-Point Protocol |
| RADIUS | Remote Authentication Dial-In User Service |
| SA | Security Association |
| SP | Service Provider |
| TACACS | Terminal Access Controller Access Control |
| | System |
| TED | Tunnel Endpoint Discovery |
| VPN | Virtual Private Network |
| VRF | VPN Routing and Forwarding |
| WINS | Windows Internet Naming Service |
| XAUTH | A technique for authentication of a user to |
| | RADIUS server. |

Many organizations use Virtual Private Networks (VPN's) to connect users and remote sites securely to their corporate network. VPN's over Internet Protocol (IP) networks often use the IP security (IPsec) protocol suite, which provides a set of cryptographically based security services. The IPsec architecture is described by Kent and Atkinson in “Security Architecture for the Internet Protocol,” published as Request for Comments 2401 by the Internet Engineering Task Force (IETF RFC 2401), November 1998, which is incorporated herein by reference.

Internet key exchange (IKE) is a sub-protocol of IPsec that authenticates each peer (determines that the sender is indeed the expected peer) in an IPsec transaction, negotiates security policy and handles the exchange of encryption keys. IKE is described by Harkins and Carrel in “The Internet Key Exchange,” IETF RFC 2409, November 1998, which is incorporated herein by reference.

The Internet Security Association and Key Management Protocol (ISAKMP) is a protocol that is part of IKE. ISAKMP defines procedures and packet formats for establishing, negotiating, modifying and deleting security associations (SA) between peers. ISAKMP is defined by Maughan, et al., in “Internet Security Association and Key Management Protocol (ISAKMP),” IETF RFC 2408, November 1998, which is incorporated herein by reference. All three RFC documents are available on the Internet at the URL “www.ietf.org/rfc”.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram that schematically illustrates a computer network, in accordance with an embodiment of the present invention;

FIG. 2 is a state diagram outlining the use of the Unity protocol, in accordance with a disclosed embodiment of the invention;

FIG. 3 is a flow chart illustrating a method for use of an IPSec Aggregator to resolve conflicts and overlaps of user attributes, in accordance with a disclosed embodiment of the invention; and

FIG. 4 is a detailed block diagram of a VPN aggregator of the computer network shown in FIG. 1, in accordance with a disclosed embodiment of the invention.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known tangible media for use with a data processing system. This includes, but is not limited to, magnetic and optical storage devices such as disk drives, magnetic tape, compact discs (CD's), digital video discs (DVD's). In addition, while the invention may be embodied in computer software, the functions necessary to implement the invention may alternatively be embodied in part or in whole using hardware components such as application-specific integrated circuits or other hardware, or some combination of hardware components and software. Alternatively, the software programming code and computer instruction may be provided as signals embodied in a transmission medium, with or without a carrier wave upon which the signals are modulated. For example, the transmission medium may include a communications network, such as the Internet.

### System Description

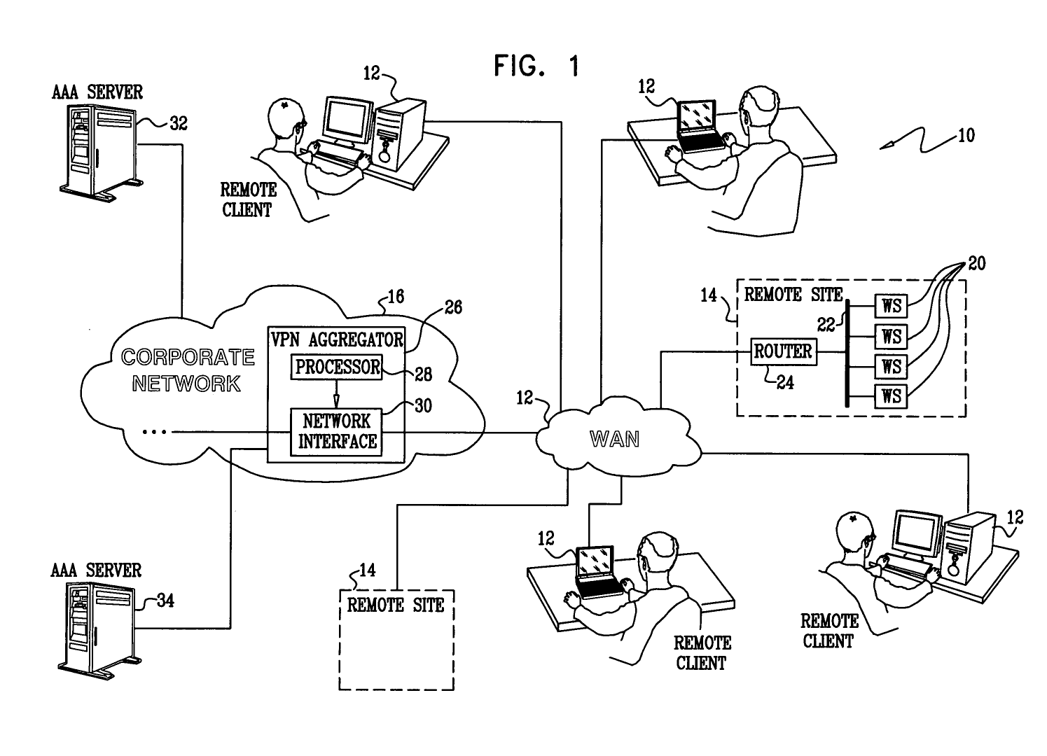

Turning now to the drawings, reference is initially made to FIG. 1, which is a block diagram that schematically illustrates a computer network 10, in accordance with an embodiment of the present invention. The network 10 comprises multiple remote clients 12 and remote sites 14 that connect to a corporate network 16 via a wide-area network (WAN 18), which is typically a public network, e.g., the Internet. The corporate network 16 is a private network that typically belongs to an organization having employees and/or customers that need to connect remotely to the organizational network. Remote clients 12 may comprise, for example, employees working from home and traveling users connecting to the network from hotel rooms or via wireless hotspots. The remote sites 14 may comprise, for example, branch offices located away from the corporate headquarters and customers or suppliers that are granted access to certain services of the corporate network. In some embodiments typical of remote branch offices, remote sites 14 may comprise a number of personal computers or workstations 20 connected by a local area network, LAN 22. The LAN 22 is connected to a wide area network, WAN 18 using a router 24. (In the description that follows, remote users are sometimes referred to as “clients” for the sake of simplicity.)

In many applications it is desirable to maintain a high level of information security when communicating over the WAN 18. For this purpose, the clients 12 and the remote sites 14 are connected to the corporate network 16 using Virtual Private Network (VPN) connections, also referred to as VPN tunnels. Each client establishes a secure VPN tunnel to the corporate network 16 via a VPN aggregator 26. In particular, the VPN aggregator 26 prioritizes the setting up of VPN tunnels for different client types based on predefined client profiles, as will be explained in detail below. In some embodiments, the VPN aggregator 26 may prioritize and set up VPN tunnels for any or all of the clients of the corporate network 16. The VPN aggregator 26 may serve more than one VPN simultaneously.

Some exemplary VPN aggregators that can use the prioritization methods described herein are the VPN 3000 series concentrators produced by Cisco Systems, Inc. (San Jose, Calif.). Details regarding these products are available on the Internet at the URL “www.cisco.com/en/US/products/hw/vpndevc/ps2284”.

Each VPN tunnel generally uses a secure communication protocol between the client and the VPN aggregator. The protocol typically uses mutually agreed encryption keys to encrypt and decrypt the information being transferred. In some embodiments, the corporate network 16 and the WAN 18 comprise Internet Protocol (IP) networks that communicate by exchanging IP packets. In these embodiments, the exchange of packets within and between these networks is performed in accordance with the IPsec and IKE protocols, as defined and described in the IETF RFC's cited above.

The network configuration shown in FIG. 1 is an exemplary configuration chosen for conceptual clarity. In general, the network 10 may comprise any number of remote clients and/or remote sites. The remote clients and sites may be connected to the WAN 18 using any suitable wired or wireless links. The VPN aggregator 26 may comprise any network element, which may serve as the gateway connecting the corporate network 16 to the WAN 18, or may be part of any other suitable configuration that connects the two networks. While the VPN aggregator 26 is shown as a component of the corporate network 16, alternatively, the VPN aggregator may be placed in a Service provider (SP) network. In such a case, the Service provider network may include multiple VPN's, each of which can be treated as a different corporate network.

The corporate network 16 may comprise a private network or may be implemented as part of a shared public network whose services are provided by a service provider.

Although the embodiments described herein mainly relate to a “responder mode” in which the clients initiate the setting up of VPN tunnels with network 16, the methods and systems described herein can be used, mutatis mutandis, in an “initiator mode” in which the VPN aggregator 26 initiates the setting up of the VPN tunnels.

The VPN aggregator 26 comprises an aggregation processor 28, which performs the various functions associated with setting up and managing the VPN tunnels, and a network interface 30, for communicating with the WAN 18 and with the different components of the corporate network 16. Typically, the processor 28 of the VPN aggregator 26 comprises a general-purpose computer, which is programmed in software to carry out the functions described herein. The software may be downloaded to the computer in electronic form, over a network, for example, or it may alternatively be supplied to the computer on tangible media, such as CD-ROM. Further alternatively, the processor 28 may be implemented using a combination of hardware and software elements. The processor may be a standalone unit, or it may alternatively be integrated with other computing platforms of the corporate network 16.

The corporate network 16 is additionally connected to one or more Authentication, Authorization, and Accounting Servers (AAA server(s)), which provides an extra level of protection and control during access of the corporate network 16. The VPN aggregator 26 may be linked to any number of AAA servers, represented in FIG. 1 as AAA servers 32, 34.

Typically, a newly joining client sends an IKE request packet to the VPN aggregator 26, requesting to set up a VPN connection (tunnel) to the corporate network 16. The VPN aggregator 26 receives the request packet and performs a tunnel setup process that authenticates the client and exchanges encryption keys. The tunnel setup process may require username and password authentication via at least one of the AAA server 32, 34 (also sometimes referred to as RADIUS servers). The AAA servers 32, 34 maintain or are connected with one or more databases.

In general, before a connection can be established with one of the remote sites 14 and clients 12 via the corporate network 16, messages are exchanged between the VPN aggregator 26 and the AAA servers 32, 34, e.g., using the well-known RADIUS protocol, to initiate checks in the AAA servers 32, 34 on the identity and access rights of the client. If the report from the AAA servers is positive, i.e., the client is authorized and authenticated. The VPN aggregator 26 then proceeds with the establishment of a VPN tunnel between the corporate network 16 and the client 24.

Among other attributes, the client is expected to have a unique routable IP address. As the supply of available IP addresses is restricted, such addresses can be dynamically assigned, which can result in inconsistencies when identifying the same client in different sessions. Such inconsistencies have historically been resolved by the AAA server.

However, in configurations such as shown in FIG. 1, the issue is more complex, as there are a plurality of AAA servers 32, 34, which do not in general coordinate with one another. Indeed, the AAA servers 32, 34 may belong to entities having no common interest, for example, competitors that share services offered by a common third party via the corporate network 16 and the VPN aggregator 26. The client 12 may have relationships with both entities, and may be known to the AAA servers 32, 34 by different attributes. The VPN aggregator 26 does not undertake the burden of routing an access attempt by the client 12 to a particular one of the AAA servers 32, 34. Rather, both AAA servers 32, 34 can be involved in an access negotiation, as explained in the deployment scenarios below.

In many cases, the IKE process of setting up a VPN tunnel for a newly-joining client is a long and computation-intensive process that consumes a significant amount of time and computation resources in the VPN aggregator 26. The length and complexity of this process are partly due to the algebraic calculations associated with generating the encryption keys. In some cases, the VPN aggregator 26 may need to communicate with other nodes in the corporate network 16 in order to authenticate a particular client, which further lengthens the tunnel setup process.

At a high level, IKE creates an authenticated, secure channel between the two IKE peers, called the IKE security association. An IKE session can be thought of being broken into two phases. The Phase 1 of the session is an exchange during which the peers authenticate each other and exchange keying material. A Diffie-Hellman key agreement is always performed in this phase.

In phase 2, IKE negotiates the IPSec security associations and generates required key material for IPSec. The sender offers at least one transform set, possibly more than one, which is used to specify an allowed combination of transforms with their respective settings. The sender also indicates the data flow to which the transform set is to be applied. The receiver then sends back a single transform set, which indicates the mutually agreed upon transforms and algorithms for the particular IPSec session. A new Diffie-Hellman agreement may be accomplished in phase 2, or the keys may be derived from the phase 1 shared secret.

### Configuration for Remote Clients.

Continuing to refer to FIG. 1, the AAA servers 32, 34 can be configured to process remote clients. AAA servers suitable for use as the AAA servers 32, 34 are available from Cisco. However, any RADIUS compliant servers may be used as the AAA servers 32, 34.

The Unity protocol is used by the VPN aggregator 26 during the IPSec activities. It supports the use of IPSec tunnel mode in remote access environments along the lines of the PPP/L2TP model. The Unity protocol is exemplary. Other protocols may be also adapted by those skilled in the art in order to apply the teachings of the invention.

The Unity protocol operates based on the notion of a client group. An ISAKMP client configuration group is a group of Unity clients that share the same identity, authentication material and configuration (policy) information. A Unity client must identify and authenticate itself by group first, and if XAUTH-enabled, by user later. Using the XAUTH feature, the client waits for a “username/password” challenge after the IKE security association has been established. When the end user responds to the challenge, the response is forwarded to the IPsec peers for an additional level of authentication. The information that is entered is checked against the AAA server.

The Unity protocol changes the standard operation of IKE by adding exchanges between IKE Phase 1 and Phase 2 (known as Phase 1.5). Phase 1 can be said to authenticate the group and Phase 1.5 to authenticate the user. The additional exchanges include an extra authentication step beyond those taken in Phase 1. Phase 2 then proceeds conventionally.

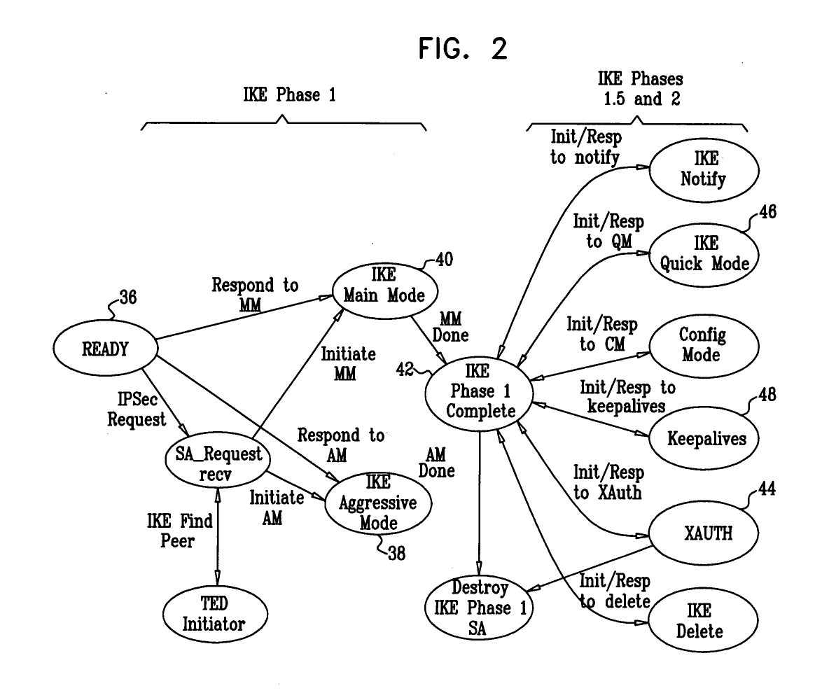

Reference is now made to FIG. 2, which is a state diagram outlining the use of the Unity protocol, in accordance with a disclosed embodiment of the invention. The protocol operates in a client/server mode, in which the client always initiates the operation (state 36), implements IKE continuous channel mode and supports use of either 1) aggressive mode (state 38) and pre-shared keys or 2) main mode (state 40) and certificates. RADIUS servers can be used to store client group configuration information (including a pre-shared group password in case of aggressive mode and MODE-CONFIG information) as well as to authenticate users (XAUTH).

Assuming use of aggressive mode and pre-shared keys, and RADIUS servers for storing client group configuration information and for user authentication, the Unity protocol operates as follows:

### Phase 1.

The Unity client initiates IKE Phase 1 (state 36). The client identifies itself using a pre-shared group name IKE ID or OU name in certificate. The client proposes all possible IKE policies that it can support. The Unity server authenticates the client device using the pre-shared key as determined by the group name or by validating a certificate using the specified CA server, arriving at state 42.

### Phase 1.5.

As shown in FIG. 2, there are alternative possibilities. If the IKE SA negotiates use of XAUTH (state 44), the client waits for a challenge and responds. The server authenticates the user, typically using one or more AAA servers. The client requests MODE-CONFIG parameters from the AAA server. These include IP address; IP addresses of DNS and WINS servers, default domain name and ACL's to be applied if split tunneling is enabled.

### Phase 2.

The client then initiates Quick Mode (state 46) and IPSec SA's are negotiated. During the negotiation, keep-alive exchanges may occur, via state 48.

### Pre-Provisioning the IPSec Aggregator and AAA Server.

Unlike a peer-to-peer mode of network operation, much of the information configured at the head-end site, e.g., the remote site 14 (FIG. 1) is VPN-specific, not tunnel end-point-specific. User-specific information includes username and password, if pre-shared keys are used, and any user-specific configuration information, e.g., a statically allocated IP address. It is assumed that the layer 3 VPN has been pre-provisioned on the IPSec VPN aggregator, and on all PE routers (VRF's, BGP, PE-PE transport).

In order to support Unity clients, a customer provides the service provider (SP) with information on IP address pools, DNS, WINS, and other policies when signing up for VPN service for remote access clients. This information may be stored locally on the IPSec Aggregator or in an AAA server managed by the SP. User-specific information such as username and passwords, as well as any user-specific policy, such as session time-outs may be stored in the SP's AAA server, or more typically, is stored at the customer's AAA server for scaling reasons. In the absence of group-wide AAA support, the customer AAA server may use the SP AAA server as a proxy for a request.

An ISAKMP client configuration group is a group of Unity clients that share the same authentication and configuration information. There is a 1:1 or N:1 mapping between VPN groups and VRF's. VPN group information consists of the following:
Password if pre-shared keys are used;
IP address or name of IP address pool on an IPSec Aggregator from which an IP address is to be assigned to the client;
IP addresses of primary and possibly secondary DNS servers;
IP addresses of primary and possibly secondary WINS servers;
Default domain name; and
Name of the access control list to be applied at the client when split tunneling is enabled.

Additional supported attributes are given in Table 2.

TABLE 2
Attribute

Include-Local-LAN attribute
perfect forward secrecy
group lock
backup server
save password
firewall are-u-there
group netmask
max-users
max-logins
WINS servers

On the IPSec Aggregator, the following information is pre-provisioned, assuming aggressive mode and pre-shared keys:
How to reach the SP-managed AAA server (global or management VPN) and customer-managed AAA servers (per customer VPN), if any;
Whether VPN group information is local or stored in an AAA server;
If local, the above client group information is configured on the IPSec Aggregator;
If remote, the name of the SP-managed AAA server to be used to fetch group configuration;
Address pools (possibly overlapping) referred to in the VPN group information, if any.
The address range is provided by customer and assigned by SP;
Enablement for the ACL's referred to in the VPN group information that are used to enforce split tunneling at the Unity client;
Definition of the ISAKMP profile including:
Matching client configuration group;
If XAUTH used, the name of the SP-managed or customer-managed AAA server to be used for user authentication; and
For each matching identity, the virtual interface to be used;
A definition of the IPSec virtual interface;
an attachment of one IPSec profile on the IPSec virtual interface;
the “transform set to be used for the client;
the ISAKMP Policy; and
preferably a RADIUS server for accounting.

It is assumed that the client has been assigned a global IP address by its local ISP with a configuration that is adequate for Internet Access. It is further assumed that VRF and the IP address of any customer or SP AAA servers, as well as any interfaces to reach them are pre-configured on the router, and that the Unity client is pre-provisioned with the following:
A public IP address or hostname of IPSec Aggregator;
Pre-shared group key with IPSec Aggregator;
XAUTH username and password or token;
IKE authentication and encryption policy;
IPSec authentication and encryption policy;
DNS server; and
the attributes shown in Table 2.

### Security Considerations (VPN Group Lock).

Remote access features must ensure that only legitimate IPSec clients and peers are forwarded using a particular VRF. This is done by appropriately authenticating the client or peer, and making sure that the identified peer is mapped to the assigned VRF. A peer-to-VRF association needs to be pre-provisioned, typically either on the IPSec Aggregator or in an AAA server. For a Unity client, there are two identifiers used and two steps to the authentication process, the IKE ID authentication in Phase 1 and user authentication in Phase 1.5. The identifiers used in both cases must match those configured for the VRF. Relying only on knowledge of the Phase 1 authentication in the Unity protocol is insufficient since the keying material is the same for all clients belong to the same VPN. Furthermore, this information may be stored on insecure equipment, e.g., laptops that are easily stolen. The risk of not matching an identifier to a VPN is that legitimate users of one VPN on the IPSec Aggregator can also be mapped into any other VPN on the IPSec Aggregator. For example, if an IPSec Aggregator serves two VPN's, one for Cisco users and one for Nortel users, a legitimate Nortel user could access the Cisco VPN using a Cisco laptop if the username were not checked to make sure that it belongs to cisco.com. The use of per-VRF AAA servers for user authentication does alleviate some of the security risk of allowing unauthorized users into a VPN. However, whenever an AAA server (or any other database) is used to authenticate users belonging to multiple VPN's, it must be ensured that the authenticated user is mapped to an appropriate VRF.

### AAA Server.

The AAA (RADIUS) server is used for user authentication (XAUTH) in the Unity protocol. Customers may use different authentication methods including username and password, and token-based schemes such as SecureID™. The former is supported; the latter may only be used via a RADIUS proxy. While RADIUS proxies are used with the AAA servers in the current embodiment, this is not critical, and other protocols may be used, e.g., TACACS.

The RADIUS server can also be used for storing configuration information that is downloaded to the client and the IPSec Aggregator, in order to enable a successfully authenticated client to use the service authorized. Both the RADIUS server and the IPSec Aggregator authorize the client as well as limiting the amount of pre-provisioning and re-provisioning that is necessary on each client and on each IPSec Aggregator. This is critical when there are many Unity clients. Furthermore, it is desirable to avoid as much per-user and per-VPN provisioning as possible on the IPSec Aggregator.

The following IPSec-related configuration information is potentially stored on the IPSec Aggregator:
Pre-shared key per Unity group or per IPSec peer;
Unity group configuration (MODE-CONFIG);
IKE policies; and
ISAKMP profile (determines VRF, key-ring, authentication and authorization list, and other IKE related info).

In Phase 1, the AAA server can be used for the following purposes:
to store a pre-shared key for IKE Phase 1 authentication purposes in the case of an IPSec peer, using IKE Aggressive mode or a Unity client. The IPSec Aggregator downloads this key at the start of IKE Phase 1; and
to store VPN configuration information that is downloaded to the Unity client in MODE-CONFIG. However, some of the information downloaded is a pointer to information that needs to be pre-provisioned on the IPSec Aggregator. This includes the IP address pool from which an IP address is to be assigned and the access control list that is to be downloaded to a client to enable split tunneling.

The IPSec Aggregator should be able to download the following information from the AAA server as well:
IP address;
IP address pool and optionally a net mask; and
ACL for split tunneling.

### Deployment Scenarios.

The service provider may provide service to a number of different enterprise customers. All AAA services could be provided either by a centralized SP AAA server, or by AAA servers at each enterprise customer site or some combination thereof.

For remote access users it is assumed pre-shared keys are used for IPSec authentication and RADIUS is used for authorization and authentication. The authorization and authentication of VPN clients essentially has three distinct phases:

In a first phase, the IPSec aggregator (GSR) verifies that the pre-shared key presented by the client is valid; i.e., it compares the pre-shared key presented by the client to that configured on the AAA server for the group to which the client belongs. For example, all the VPN clients from Cisco might come in with a group name of “ciscogroup” and a pre-shared key of “keycisco”. Now, on the AAA server, a user named “ciscogroup” would be configured with one of the AV pairs specifying the pre-shared key. If this phase succeeds, IKE begins, and the user is prompted for the XAUTH information (userid and password).

In a second phase (XAUTH), the user provides a userid and password. This information is passed to RADIUS for authentication. The SP needs to determine the enterprise customer to which the user belongs. Thus, it is normal for the user to specify a fully qualified user name, e.g., user@cisco.com. The SP can use the domain name to determine the enterprise customer to whom the user belongs and process the authentication accordingly.

In a third phase, essentially corresponding to MODE-CFG, the IPSec Aggregator requests all the configuration parameters that the RADIUS server is configured to provide. These parameters are usually configured as AV Pair attributes (e.g., the pool from which the client should be handed an IP address) for the group name that is known to RADIUS. The RADIUS server thus authenticates the user. If authentication is satisfactory, the parameters are automatically returned to the IPSec Aggregator in a reply.

Regarding the authorization and authentication procedures described above, the following models are also commonly used by service provider:

### SP AAA Server Used as a RADIUS Proxy.

The SP AAA server can store information on the customer behalf, or the service provider's AAA server will need to act as a Radius proxy for the customer's AAA server.

### EXAMPLE 1

The SP AAA server provides authorization and the enterprise AAA server provides authentication. The SP verifies the pre-shared key for all users. The enterprise is responsible for maintaining all user information and authenticating its users. In this situation, the SP AAA server acts as a proxy, receiving a request from a router, which it then delegates to an Enterprise AAA server. The Enterprise AAA server thereupon performs the authentication procedure.

### EXAMPLE 2

The Enterprise AAA server provides both authorization and authentication. An enterprise might elect this model in order to maintain full control of the entire process. In this case, the SP AAA server would be configured to act as a proxy for all authorization and authentication requests for the enterprise's users to the enterprise AAA server. A configuration example is shown in Listing 1.

### Customer AAA Server Used Directly on a Per VRF Basis.

In this model, the IPSec Aggregator uses the information stored in the customer's AAA server directly. It is achieved as follows: the ISAKMP profile is mapped based on the identity (ID_KEY_ID), which is the group name, passed by the remote client in the phase 1 exchange (FIG. 2). Then the appropriate AAA list name is chosen upon the ISAKMP configuration. A configuration example is shown in Listing 2.

### Different AAA Servers for Authentication and Authorization.

In this model, the SP AAA server is used only for authorization. It is possible to download group attributes. The customer AAA server is used for authentication on a per VRF basis, as in the immediately preceding model. An example is shown in Listing 3.

### Attribute Conflict Resolution.

From consideration of the above-described scenarios, it will be apparent that, a remote access user can be authenticated, authorized and configured using attributes stored in different AAA servers or on the IPSec Aggregator, in various combinations. In general, the attributes are fetched from AAA servers using the user ID and the group ID to which the user belongs. Corresponding attributes from different sources may conflict. According to an aspect of the invention, the VPN gateway, e.g., the IPSec Aggregator, is responsible for resolving overlaps or conflicts among user/group attributes, e.g., overlapping IP address pools, according to a governing policy. Resolution by the IPSec Aggregator is performed automatically, without intervention of a human operator. The policy can be global. However, it can also be attribute-specific. In general, none of the AAA servers is aware of possible conflicts with attributes stored in other AAA servers. Indeed, the AAA servers may be unaware of the existence of one another.

A VPN gateway administrator can configure a policy to determine the behavior for each AAA attribute:

<policy-name> <attribute-name> [group|user|local-value].

For each AAA attribute, an administrator can independently define and set a precedence between corresponding user and group attributes. The administrator is also able to specify a value to be used for a particular attribute when a conflict occurs.

In the case of VPN services, the configured policy is attached to an ISAKMP profile. The policy can also be used for other services that make use of the AAA server, e.g., routers, logged-in users, and PPP users.

### EXAMPLE 3

Assume a deployment of a SP-owned (Telecom Co. A) IPSec aggregator to serve multiple customers (Corporation A, Corporation B) for VPN services. Corporation A and Corporation B each maintain an AAA server, which is linked to the IPSec Aggregator.

The IPSec Aggregator is configured to authenticate remote clients using the customer AAA server and to authorize remote clients using the SP AAA servers.

When a remote client, who for purpose of this Example, is a customer of Corporation A, attempts to connect to a remote site via a VPN, the IKE session accesses both customer AAA servers and SP AAA servers. Some attributes may conflict, e.g., the local IP address pool name. It is also possible that two different attributes, which have a meaning that is dependent on one another will cause a conflict in case both of them are received. A governing policy is in force, which anticipates such conflicts.

For example, a framed IP address and an address pool may be received. The policy may dictate that the framed IP address is used instead of the address pool. However, if the framed IP address has a member of a list of special values, then it is ignored, and a check is made to determine if an address pool attribute exists.

The IPSec Aggregator implements the policy to resolve the conflict. In this example, policy dictates that all attributes of the SP AAA server override those of customer AAA servers. Thus, should the attributes of the Corporation A AAA server conflict with those of the SP AAA server, attributes maintained on the IPSec Aggregator will control.

Similarly, according to this policy, should the attributes of either the Corporation A AAA server or the attributes of the SP AAA server conflict with attributes known to the IPSec Aggregator, the attributes of the IPSec Aggregator control.

### Operation.

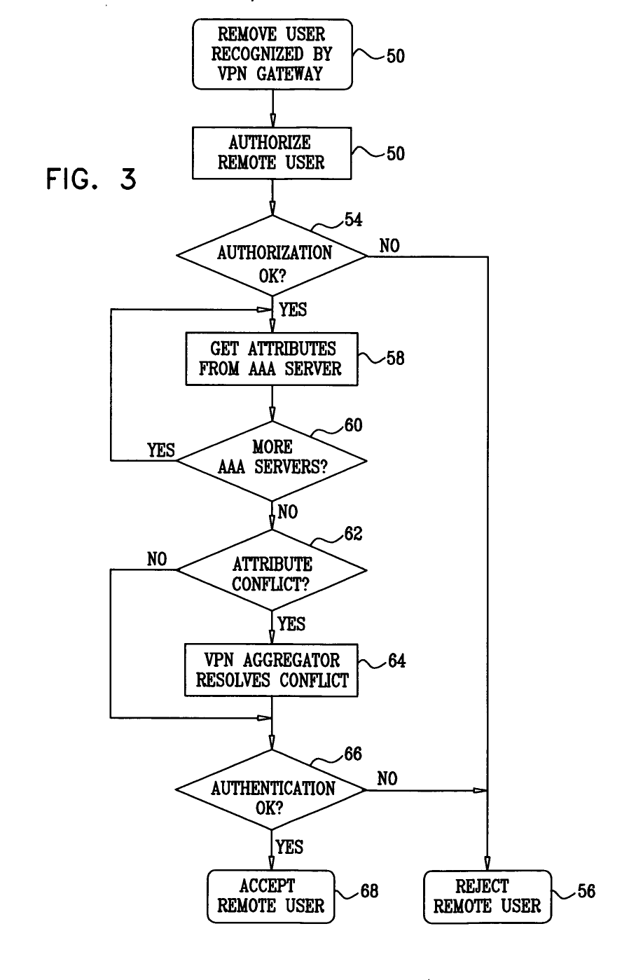

Reference is now made to FIG. 3, which is a flow chart illustrating a method for use of an IPSec Aggregator to resolve conflicts and overlaps of user attributes, in accordance with a disclosed embodiment of the invention. A network arrangement such as the example of FIG. 1 is assumed. Remote clients access the sites of Corporations via the corporate network 16 (FIG. 1), typically, via a VPN.

At initial step 50 a governing policy is placed in effect in the IPSec Aggregator. For purpose of explanation, it is assumed that the governing policy is that described in Example 3. However, the principles disclosed herein can be used with many different governing policies. For example, such a policy may dictate that the attributes stored in the AAA server of Corporation A override all others. A remote client attempts to connect to a remote site and is recognized by the VPN gateway.

Next, at step 52, authorization of the remote client occurs. As noted above, authorization is performed by the IPSec Aggregator. As noted above, the IPSec Aggregator may access a SP AAA server and receive group attributes at this stage.

Control now proceeds to decision step 54, where it is determined if authorization was successful. If the determination at decision step 54 is negative, then control proceeds to final step 56. The remote client is refused access, and the procedure terminates.

If the determination at decision step 54 is affirmative, then authentication of the remote client commences. It will be recalled from Example 3 that this authorization accomplished by reference to user attributes stored on the AAA servers. Control proceeds to step 58. One of the AAA servers is accessed and user attributes retrieved into the IPSec Aggregator.

Control now proceeds to decision step 60, where it is determined if more AAA servers are to be accessed. If the determination at decision step 60 is affirmative, then control returns to step 58. In Example 3 there are two AAA servers. However, the method is applicable to any number of AAA servers.

If the determination at decision step 60 is negative, then control proceeds to decision step 62, where it is determined if there are any conflicts between the user attributes obtained from the AAA servers, or with group attributes that may have been received from a AAA server during authorization in step 52 in iterations of step 58.

If the determination at decision step 62 is affirmative, then control proceeds to step 64. The conflict is resolved by the IPSec Aggregator, using the governing policy currently in force. Control proceeds to decision step 66.

If the determination at decision step 62 is negative, then control proceeds directly to decision step 66.

At decision step 66 it is determined whether the user attributes allow the user to be authenticated. If the determination at decision step 66 is negative, then control proceeds to final step 56. The user is rejected.

If the determination at decision step 66 is affirmative, then control proceeds to final step 68. The user is accepted, and the establishment of the VPN tunnel proceeds conventionally. The procedure ends.

The procedure described above can be modified to accommodate many different configurations and policies. However, in all of them, it is the VPN gateway, i.e., the IPSec Aggregator, which identifies and resolves attribute overlap and conflicts. Because the policy can be flexibly configured, it is possible to resolve ambiguities at different levels, e.g., per-user AAA attributes and per-group AAA attributes. For example, the name of an address-pool may be received from a group authorization reply. Then a static-framed-IP may be received from a user authentication reply. The static-framed-IP that was received as a user attribute overrides the address-pool that was received as a group attribute, although they are two distinct attributes.

### VPN Aggregator.

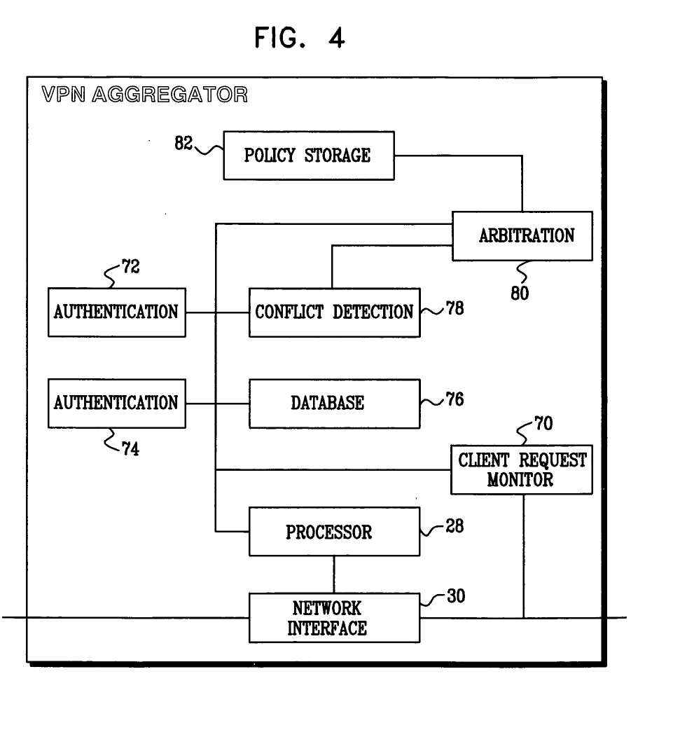

Reference is now made to FIG. 4, which is a detailed block diagram of the VPN aggregator 26 (FIG. 1) in accordance with a disclosed embodiment of the invention. The organization and operation of the VPN aggregator 26 will now be more clearly understood from consideration of the method disclosed with reference to FIG. 3. The VPN aggregator 26 is typically realized as a computer in which the processor 28 has a memory that contains objects corresponding to the functional blocks depicted in FIG. 4.

The VPN aggregator 26 includes a client request module 70 that monitors incoming access requests from remote clients. Incoming requests are referred to an authentication module 72, and an authorization module 74. Client user attributes may be optionally stored in a database 76, which can be integral with the VPN aggregator 26 as shown in FIG. 4. Alternatively, the database 76 may be remote from the VPN aggregator 26. The authentication module 72 and the authorization module 74 access AAA servers 32, 34 (FIG. 1) via the interface 30. A conflict detection module 78 cooperates with the authentication module 72 and the authorization module 74 to detect overlaps or inconsistencies in client user attributes obtained from the AAA servers 32, 34. Once such an inconsistency is detected, an arbitration module 80 applies a governing policy, stored in a memory 82 to resolve the conflict. The resolution is reported to the authentication module 72 and the authorization module 74 as appropriate. The attribute conflict is not generally reported to the AAA servers 32, 34, but is handled within the VPN aggregator 26.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

### Computer Program Listings

Listing 1

```
Configuration Example:
aaa group server radius global_aaa
  server 100.1.1.4 auth-port 1645 acct-port 1646
!
aaa authentication login acc group global_aaa
aaa authorization network acc group global_aaa
aaa  accounting  network  acc  start-stop  broadcast  group
global_aaa
...
crypto isakmp profile red-ra
    match identity group oured
    client authentication list acc
    isakmp authorization list acc
    accounting acc
```

Listing 2

```
Configuration Example:
aaa group server radius client-A
  server-private 101.1.1.1 auth-port 1645 acct-port 1646 key
nsite
  vrf client-A-vrf
aaa authentication login client-A-list group client-A
aaa authorization network client-A-list group client-A
crypto isakmp profile client-A-profile
    match identity group client-A
    client authentication list client-A-list
    isakmp authorization list client-A-list
    client configuration address respond
    accounting client-A
```

Listing 3

```
crypto isakmp profile client-B-profile
    match identity group client-B
    client authentication list client-B-list
    isakmp authorization list global-aaa
```

1. A computer-implemented method for establishing communications between a remote client and a private network using a gateway, comprising the steps of:
providing a conflict resolution policy to said gateway; and
in said gateway, performing the steps of:
receiving a request from said remote client to instantiate a connection with said private network via a public communications network;
verifying rights of said remote client to access said private network by obtaining first attributes of said remote client from a first server and obtaining second attributes of said remote client from a second server;
identifying an inconsistency between said first attributes and said second attributes; and
applying said conflict resolution policy to said first attributes and said second attributes to determine resolved attributes automatically, without intervention of a human operator;
using said resolved attributes to determine said rights; and responsively thereto, establishing said communications between said remote client and said private network.

2. The method according to claim 1, wherein said first server is accessed by said gateway to identify said remote client and said second server is accessed by said gateway to authorize said remote client to access said private network.

3. The method according to claim 1, wherein said first server is configured as a proxy for accesses to said second server and said second attributes are obtained from said second server via said first server.

4. The method according to claim 1, wherein said first attributes and said second attributes each comprise group attributes and user attributes, applying said conflict resolution policy comprises enforcing a precedence between corresponding group attributes and user attributes.

5. The method according to claim 1, wherein when one of said first attributes differs from a corresponding one of said second attributes, applying said conflict resolution policy comprises setting a predetermined value to be used for said one attribute.

6. The method according to claim 1, further comprising the step of storing third attributes of said remote client on said gateway, wherein applying said conflict resolution policy comprises enforcing a precedence between corresponding ones of said first attributes, said second attributes, and said third attributes.

7. The method according to claim 1, wherein applying said conflict resolution policy comprises editing at least one of said first attributes on said first server and said second attributes on said second server.

8. A computer software product for establishing communications between a remote client and a private network using a gateway, including a tangible computer-readable medium in which computer program instructions are stored, which instructions, when read by a processor in said gateway, cause the gateway to:
receive a request from said remote client to instantiate a connection with said private network via a public communications network;
verify rights of said remote client to access said private network, by obtaining first attributes of said remote client from a first server and obtaining second attributes of said remote client from a second server;
identify an inconsistency between said first attributes and said second attributes; and
apply a conflict resolution policy to said first attributes and said second attributes to determine resolved attributes automatically, without intervention of a human operator; and
use said resolved attributes to determine said rights; and responsively thereto, establish said communications between said remote client and said private network.

9. The computer software product according to claim 8, wherein said first server is accessed by said gateway to identify said remote client and said second server is accessed by said gateway to authorize said remote client to access said private network.

10. The computer software product according to claim 8, wherein said first attributes and said second attributes each comprise group attributes and user attributes, applying said conflict resolution policy comprises enforcing a precedence between corresponding group attributes and user attributes.

11. The computer software product according to claim 8, wherein when one of said first attributes differs from a corresponding one of said second attributes, applying said conflict resolution policy comprises setting a predetermined value to be used for said one attribute.

12. The computer software product according to claim 8, wherein third attributes of said remote client are accessible to said gateway, wherein applying said conflict resolution policy comprises enforcing a precedence between corresponding ones of said first attributes, said second attributes, and said third attributes.

13. A computer-implemented method for establishing communications between a remote client and a remote site using a VPN (Virtual Private Network) gateway having a VPN aggregator, comprising the steps of:
providing a conflict resolution policy to said VPN aggregator; and
in said VPN aggregator, performing the steps of:
receiving a request from said remote client to instantiate a connection with said remote site via a communications network;
authenticating said remote client and authorizing said remote client to access said remote site, wherein at least one of said steps of authorizing and authenticating comprises obtaining first attributes of said remote client from a first AAA (Authentication, Authorization, and Accounting) server and obtaining second attributes of said remote client from a second AAA server;
identifying an inconsistency between said first attributes and said second attributes; and
automatically applying said conflict resolution policy to said first attributes and said second attributes to determine resolved attributes;
using said resolved attributes in said at least one of said steps of authenticating and authorizing; and
thereafter establishing a VPN tunnel between said remote client and said remote site.

14. The method according to claim 13, wherein said first AAA server is accessed by said VPN aggregator in said step of authenticating and said second AAA server is accessed by said VPN aggregator in said step of authorizing.

15. A computer software product for establishing communications between a remote client and a remote site using a VPN (Virtual Private Network) gateway having a VPN aggregator, including a tangible computer-readable medium in which computer program instructions are stored, which instructions, when read by a processor in said VPN aggregator, cause said VPN aggregator to:
receive a request from said remote client to instantiate a connection with said remote site via a communications network;
authenticate said remote client and authorize said remote client to access said remote site, wherein at least one of an authentication and an authorization of said remote client comprises an evaluation of first attributes of said remote client from a first AAA (Authentication, Authorization, and Accounting) server and an evaluation of second attributes of said remote client from a second AAA server;
identify an inconsistency between said first attributes and said second attributes; and
apply a conflict resolution policy to said first attributes and said second attributes to determine resolved attributes;
use said resolved attributes to complete at least one of said authentication and said authorization; and
thereafter establish a VPN tunnel between said remote client and said remote site.

16. The computer software product according to claim 15, wherein said first attributes and said second attributes each comprise group attributes and user attributes, and an application of said conflict resolution policy comprises an enforcement of a precedence between corresponding group attributes and user attributes.

17. The computer software product according to claim 15, wherein when one of said first attributes differs from a corresponding one of said second attributes, an application of said conflict resolution policy comprises an assignment of a predetermined value for said one attribute.

18. The computer software product according to claim 15, wherein third attributes of said remote client are stored on said VPN aggregator, wherein an application of said conflict resolution policy comprises an enforcement of a precedence between corresponding ones of said first attributes, said second attributes, and said third attributes.

19. The computer software product according to claim 15, wherein an application of said conflict resolution policy comprises an edit of at least one of said first attributes on said first AAA server and said second attributes on said second AAA server.

20. A communications apparatus for providing communications via a communications network, comprising:
a network interface, linked to a plurality of clients including a remote client and a remote site; and
a VPN aggregator, which is coupled to said network interface, said VPN aggregator operative to:
receive a request from said remote client to instantiate a connection with said remote site via said communications network;
authenticate said remote client and authorize said remote client to access said remote site, wherein at least one of an authentication and an authorization comprises an evaluation of first attributes of said remote client from a first AAA (Authentication, Authorization, and Accounting) server and an evaluation of second attributes of said remote client from a second AAA server;
identify an inconsistency between said first attributes and said second attributes; and
apply a conflict resolution policy to said first attributes and said second attributes to determine resolved attributes;
use said resolved attributes to complete at least one of said authentication and said authorization; and
thereafter establish a VPN tunnel between said remote client and said remote site.

21. The communications apparatus according to claim 20, wherein said first AAA server is accessed by said VPN aggregator in said authentication and said second AAA server is accessed by said VPN aggregator in said authorization.

22. The communications apparatus according to claim 20, wherein said first AAA server is configured as a proxy for accesses to said second AAA server and said second attributes are obtained from said second AAA server via said first AAA server in said at least one of said authentication and said authorization.

23. The communications apparatus according to claim 20, wherein said first attributes and said second attributes each comprise group attributes and user attributes, and an application of said conflict resolution policy comprises an enforcement of a precedence between corresponding group attributes and user attributes.

24. The communications apparatus according to claim 20, wherein third attributes of said remote client are stored on said VPN aggregator, wherein an application of said conflict resolution policy comprises an enforcement of a precedence between corresponding ones of said first attributes, said second attributes, and said third attributes.

25. A communications apparatus for providing communications via a communications network, comprising:
a network interface, linked to a plurality of clients including a remote client and a remote site; and
a VPN aggregator, which is coupled to said network interface, said VPN aggregator comprising:
means for receiving a request from said remote client to instantiate a connection with said remote site via said communications network;
means for authenticating said remote client and authorize said remote client to access said remote site, wherein at least one of an authentication and an authorization of said remote client comprises an evaluation of first attributes of said remote client from a first AAA (Authentication, Authorization, and Accounting) server and an evaluation of second attributes of said remote client from a second AAA server;
means for identifying an inconsistency between said first attributes and said second attributes; and
means for applying a conflict resolution policy to said first attributes and said second attributes to determine resolved attributes and using said resolved attributes to complete at least one of said authentication and said authorization; and
means for establishing a VPN tunnel between said remote client and said remote site responsively to said authentication and said authorization.
